(19) United States
(12) Patent Application Publication
(10) Pub. No.: US 2011/0289871 A1
(43) Pub. Date: Dec. 1, 2011

(54) FLUSH JAMB

(76) Inventor: Farhad Vafaee, Los Angeles, CA (US)

(21) Appl. No.: 12/787,133

(22) Filed: May 25, 2010

(51) Int. Cl. E06B 1/52; E06B 1/04; E04B 1/68; E04C 3/00

(52) U.S. Cl. 52/210; 52/831; 52/745.15; 52/745.2; 52/741.4

(57) ABSTRACT

A door jamb which is flush with the wallboard. Also a door jamb which provides a pocket into which wallboard fits. The preferred embodiment of this invention comprises a central web having a first surface a second surface, a first side and a second side, with a first right triangular section at the first side and a second right triangular section at the second side. The adjacent leg of the first right triangular section is in line with the second surface and the opposite leg of the first right triangular section projects away from the first surface. Further the adjacent leg of the second right triangular section is in line with the first surface and the opposite leg of the second right triangular section projects away from the second surface.

### BACKGROUND OF THE INVENTION

(1) Field of the Invention

The present invention relates to the field of construction and more particularly to the field of door jamb molding.

(2) Description of the Related Art

Door jamb molding usually protrudes away from the wall. One purpose is to hide the cut edge of the wallboard. A number of patents and patent publications cover molding of various types.

(1) U.S. Pat. No. 6,859,977

This Patent is directed to a security storm door having a jamb that may be made of a number of high strength materials including aluminum. The lock jamb is generally Z-shaped having a flange that extends outwardly with an outwardly facing front surface on the outer flange and has an outwardly facing rear surface on the inner flange. A lock jamb includes a jamb body.

(2) U.S. Pre-Grant Publication 200910235608

This reference is directed to a support structure for a variety of uses that with the structure typically employing a plurality of triangular-shaped elements that form a low-profile structural support member that may be formed from sheet material such as aluminum using cold roll-forming or bending technology. Support structures are generally trapezoidal shaped formed by a pair of triangles. The support structures may for example be utilized in window and/or door jambs.

(3) U.S. Pat. No. 5,230,180

This Patent is directed to a door assembly having hidden screw construction including the side jambs and header of the door opening. A door mounted in an opening is surrounded by a Z-bar header and a pair of spaced apart jamb Z-bars. Each has a back flange, middle flange and front flange. The front flanges are each provided with a vertically extending channel having a channel bottom wall that receives a plurality of screws that secure the Z-bars to the door opening jambs.

(4) U.S. Pat. No. 6,408,922

This Patent is directed to a self-supporting construction frame for installation of doors and windows. The construction frame can be used for example, for the installation of in or out-swinging doors, screen doors, retractable screen doors, screens for windows, windows, and accordion doors. Construction frame may be mounted either on the inside of an existing doorway or on the outside of the doorway. A plurality of clips can be used to attach the jamb to the guiderails A jamb and jamb support can be used for construction of a face mounting frame. The jamb can be installed directly onto the door frame for inside door frame installations. The jamb can be directly fastened to the jamb support for door face installations. The jamb may include predrilled clearance holes for mounting and the jamb support has matching tapped holes to accept fastening screws from the jamb.

(6) U.S. Pat. No. 6,993,875

This Patent is directed to building elements useful in construction. It shows the integration of wall panels with a door using a suitable decorative extrusion. The door is integrated with the wall system of the invention but includes an extrusion which carries a channel for a felt strip or other insulating strip. The extrusion is a door stop. The extrusion is mounted on a decorative extrusion which ends the wall system forming a door jamb. The door may be mounted between walls using the system of the invention. Felt is placed in the channel of the extrusion. The channel and the felt provide a rest stop for the door.

None of these inventions provides a door jamb that is flush with the wallboard. Further, none of these inventions provides a pocket into which the wallboard can fit.

Development of a door jamb which, when fastened in place, is flush with the wallboard represents a great improvement in the field of construction and satisfies a long felt need of architects and builders. Development of a door jamb which, when fastened in place, provides a pocket into which the wallboard fits represents a great improvement in the field of construction and satisfies a long felt need of architects and builders.

### SUMMARY OF THE INVENTION

The present invention is a door jamb which, when fastened in place, is flush with the wallboard. This invention is also a door jamb which, when fastened in place, provides a pocket into which the wallboard fits

The preferred embodiment of this invention comprises a central web having a first surface a second surface, a first side and a second side, with a first right triangular section at the first side and a second right triangular section at the second side. The adjacent leg of the first right triangular section is in line with the second surface and the opposite leg of the first right triangular section projects away from the first surface. Further the adjacent leg of the second right triangular section is in line with the first surface and the opposite leg of the second right triangular section projects away from the second surface.

A first alternate embodiment comprises a central web having a first surface a second surface, a first side and a second side with a first rectangular section at the first side and a second rectangular section at the second side. One side of the first rectangular section is in line with the second surface and the perpendicular side of the first rectangular section projects away from the first surface. Further one side of the second rectangular section is in line with the first surface and the perpendicular side of the second rectangular section projects away from the second surface.

A second alternate embodiment comprises a central web having a first surface, a second surface, a first side and a second side. There is a first rectangular section at the first side, which has a first side, a perpendicular side, and an opposite side. The first side and perpendicular side are at right angles to each other and the first side and the opposite side are parallel to each other.

There is a second rectangular section at the second side which has a first side, a perpendicular side and an opposite side. The first side and perpendicular side are at right angles to each other and the perpendicular side and the opposite side are parallel to each other. The first side of the first rectangular section is in line with the second surface and the perpendicular side of the first rectangular section projects away from the first surface. The first side of the second rectangular section is in line with the first surface and the perpendicular side of the second rectangular section projects away from the second surface.

There is a third rectangular section at the opposite side of the first rectangular section, which has a first side and a perpendicular side, perpendicular to each other. The perpendicular side of the third rectangular section is longer than the opposite side of the second rectangular section. The first side of the third rectangular section is in line with the perpendicular side of the first rectangular section and the perpendicular side of the third rectangular section is parallel to the opposite side of the first rectangular section.

There is a fourth rectangular section at the opposite side of the second rectangular section, which has a first side and a perpendicular side, perpendicular to each other. The perpendicular side of the fourth rectangular section is longer than the opposite side of the second rectangular section. The first side of the fourth rectangular section is in line with the first side of the second rectangular section and the perpendicular side of the fourth rectangular section is parallel to the opposite side of the second rectangular section.

The jamb is perceived as part of the wall, rather than part of the door. In other words the door jamb disappears. This invention works on all framing sizes—2″×4″ wall as well as 2″×8″. You do not need to have different size jambs for different size walls. This invention yields streamlined, modern look.

The preferred and first alternate moldings can be used to construct a door frame in a door opening. The molding is cut to size and fastened to the framing, with the corner guide against the framing corner. Wallboard is cut as accurately as possible to match the fastened jamb molding and fastened to the framing. Any spaces between the wallboard and molding are patched with spackle.

The second alternate molding can be used to construct a door frame in a door opening. The molding is cut to size and fastened to the framing, which creates a slot between the framing and the molding. Wallboard is cut to match the molding, slid into the pocket and then fastened to the framing. No patching is necessary. The projection can be shaped to variety of decorative and expressive shapes.

An appreciation of the other aims and objectives of the present invention and an understanding of it may be achieved by referring to the accompanying drawings and description of a preferred embodiment.

### BRIEF DESCRIPTION OF THE DRAWINGS

FIG. 1 is an isometric view of the preferred embodiment of this invention.

FIG. 2 is a view of a small segment of the preferred embodiment from one end, the view from the other end being identical.

FIG. 2A is a view of a small segment of the preferred embodiment looking at one surface and one hypotenuse.

FIG. 2B is a view of a small segment of the preferred embodiment looking at the other hypotenuse and one opposite.

FIG. 2C is a view of a small segment of the preferred embodiment looking the other surface and the other hypotenuse.

FIG. 2D is a view of a small segment of the preferred embodiment looking at one hypotenuse and the other opposite.

FIG. 3 is a horizontal cross section of the preferred embodiment installed in a doorway with the door in the closed position.

FIG. 3A is a vertical cross section of the preferred embodiment installed in a doorway with the door in the closed position.

FIG. 4 illustrates the naming conventions for the sides of a right triangle.

FIG. 4A illustrates one way of conceiving of the preferred embodiment of this invention.

FIG. 5 is a front view showing the preferred embodiment of this invention installed in door framing.

FIG. 6 is a horizontal cross section of an alternate embodiment of this invention installed in a doorway with the door in the closed position.

FIG. 6A illustrates one way of conceiving of an alternate embodiment of this invention.

FIG. 7 is a view of a small segment of this alternate embodiment from one end, the view from the other end being identical.

FIG. 7A is a view of a small segment of this alternate embodiment from one side.

FIG. 7B is a view of a small segment of this alternate embodiment from the top.

FIG. 7C is a view of a small segment of this alternate embodiment from the other side.

FIG. 7D is a view of a small segment of this alternate embodiment from the bottom.

FIG. 8 is a horizontal cross section of another alternate embodiment of this invention installed in a doorway with the door in the closed position.

FIG. 8A illustrates one way of conceiving of the other alternate embodiment of this invention.

FIG. 9 is a view of a small segment of this alternate embodiment from one end, the view from the other end being identical.

FIG. 9A is a view of a small segment of this alternate embodiment from one side.

FIG. 9B is a view of a small segment of this alternate embodiment from the top.

FIG. 9C is a view of a small segment of this alternate embodiment from the other side.

FIG. 9D is a view of a small segment of this alternate embodiment from the bottom.

FIG. 10 shows some variations of this invention illustrated with the alternate embodiment.

FIG. 11 shows some other variations of this invention illustrated with the alternate embodiment.

### DETAILED DESCRIPTION OF THE PREFERRED EMBODIMENT

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

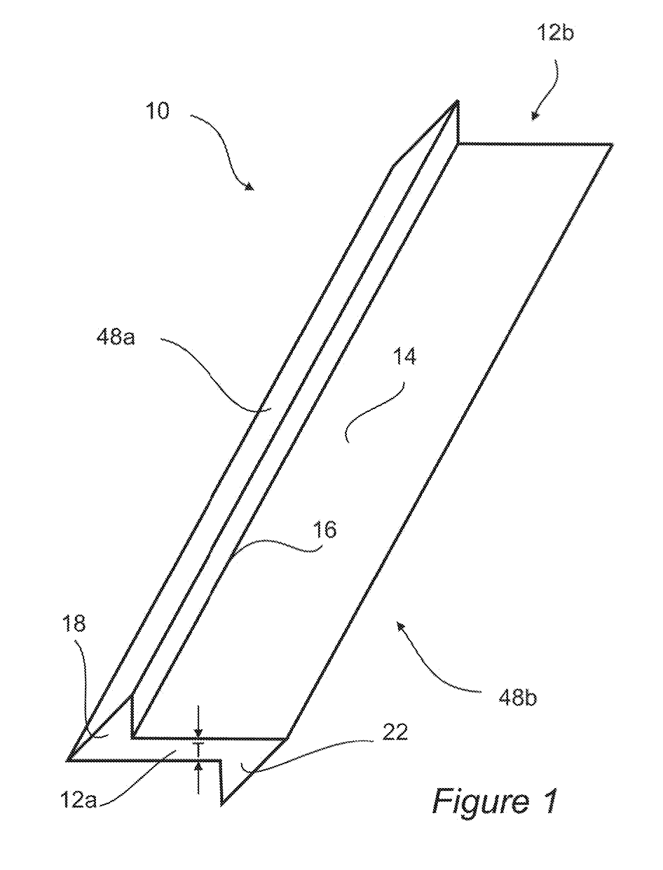

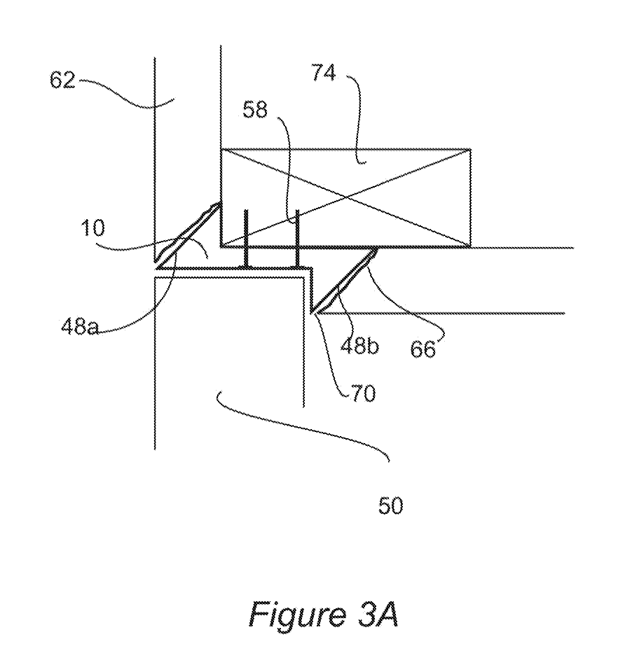

FIG. 1 is an isometric view of the preferred embodiment 10 of this invention, which will be provided in discrete lengths and thus has ends 12a, 12b. FIG. 4 illustrates the naming conventions for the sides of a right triangle. This embodiment 10 may be thought of as a central web 14 with first and second right triangles 18, 22 at first and second sides 24a, 24b. See FIG. 4A. The central web 14 has a first 26 surface and a second surface 30. Each right triangle 18, 22 has an adjacent leg 34, 42 and an opposite leg 38, 46. The adjacent leg 34 of first triangle 18 is in line with the first surface 26 while the adjacent leg 42 of the second triangle 22 is in line with the second surface 30. The opposite leg 38 of first triangle 18 projects at right angles to the first surface 26 and the opposite leg 46 of the second triangle 22 projects at right angles from the second surface 30. The lengths of the opposite legs 38, 46 are greater than the thickness T of the web 14. Also the lengths L of the opposite 38 and adjacent 42 legs are the same thickness W as the wallboard. The corner 16 is used as a guide as will become apparent from subsequent description.

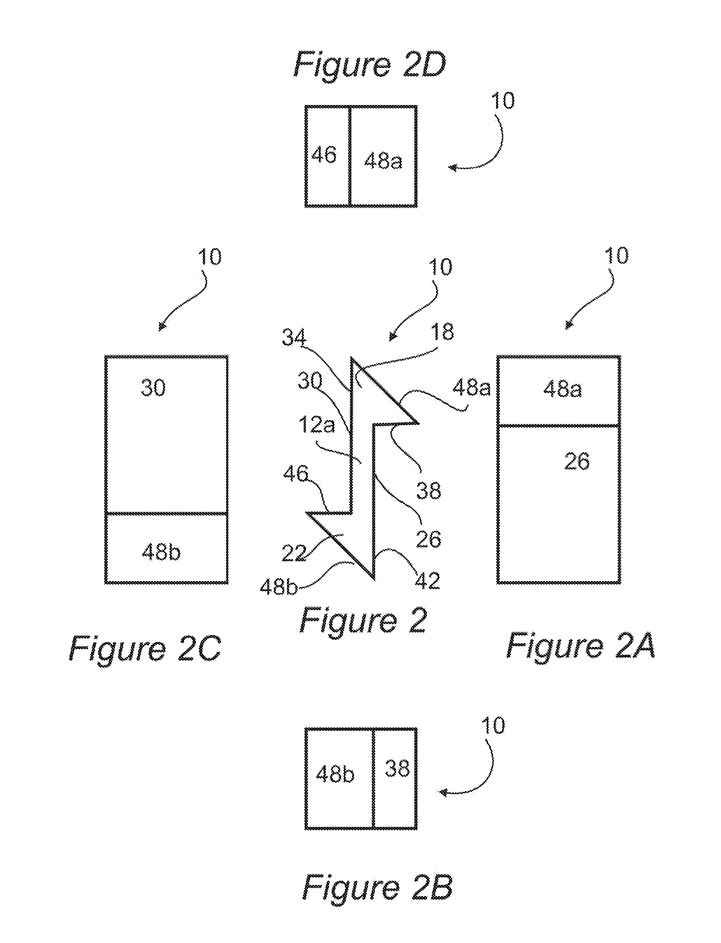

FIG. 2 is a view of a small segment of the preferred embodiment 10 from one end, 12a the view from the other end 12b being a mirror image. FIG. 2A is a view of a small segment of the preferred embodiment 10 looking at one surface 26 and one hypotenuse 48a. FIG. 2B is a view of a small segment of the preferred embodiment 10 looking at the other hypotenuse 48b and one opposite 38. FIG. 2C is a view of a small segment of the preferred embodiment 10 looking the other surface 30 and the other hypotenuse 48b. FIG. 2D is a view of a small segment of the preferred embodiment 10 looking at one hypotenuse 48a and the other opposite 46.

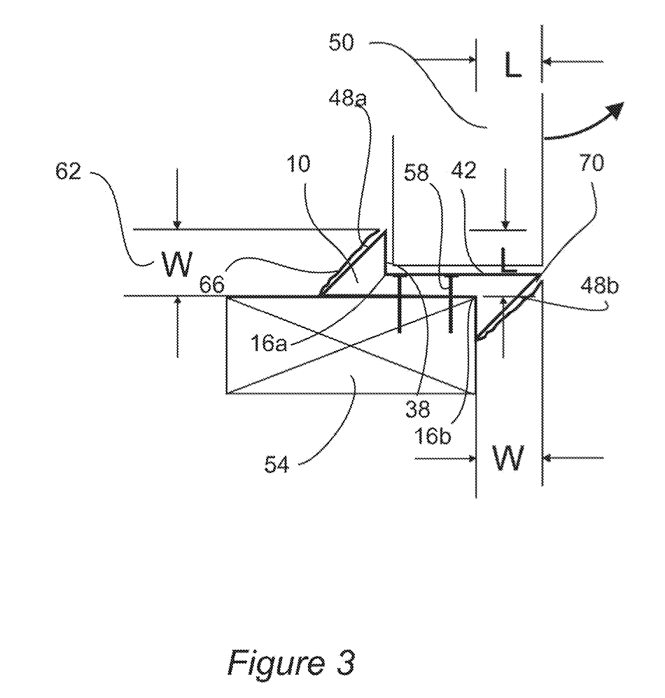

FIG. 3 is a partial horizontal cross section of the preferred embodiment 10 installed in a doorway with the door 50 in the closed position. The jamb 10 is fastened to a stud 54 preferably with nails 58 although other means of fastening could be used. One corner 16b is used to position the jamb 10 tight against the corner of the stud 54. The other corner 16a receives the corner of the door 50. Side 38 functions as a door stop.

FIG. 3A is a partial vertical cross section of the preferred embodiment 10 installed in a doorway with the door 50 in the closed position. The jamb 10 is fastened to a header 74 preferably with nails 58. Wallboard 62 is cut to fit around the doorway. The edge that will fit against the jamb 10 is cut at an angle matching the angle of the hypotenuses 48a, 48b. Since wallboard 62 is frangible, the cut surface 66 is typically rough and not at a perfect angle. Therefore, later on, spackle or equivalent is used to fill in the gaps 70.

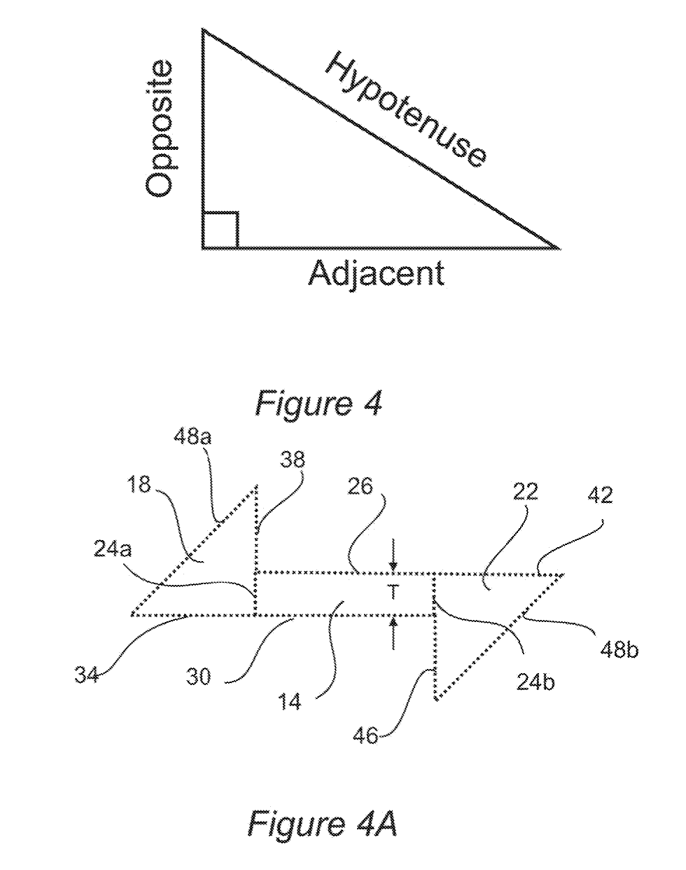

FIG. 5 is a front view showing the preferred embodiment 10 of this invention installed in the stud 54 and header 74 of a door opening.

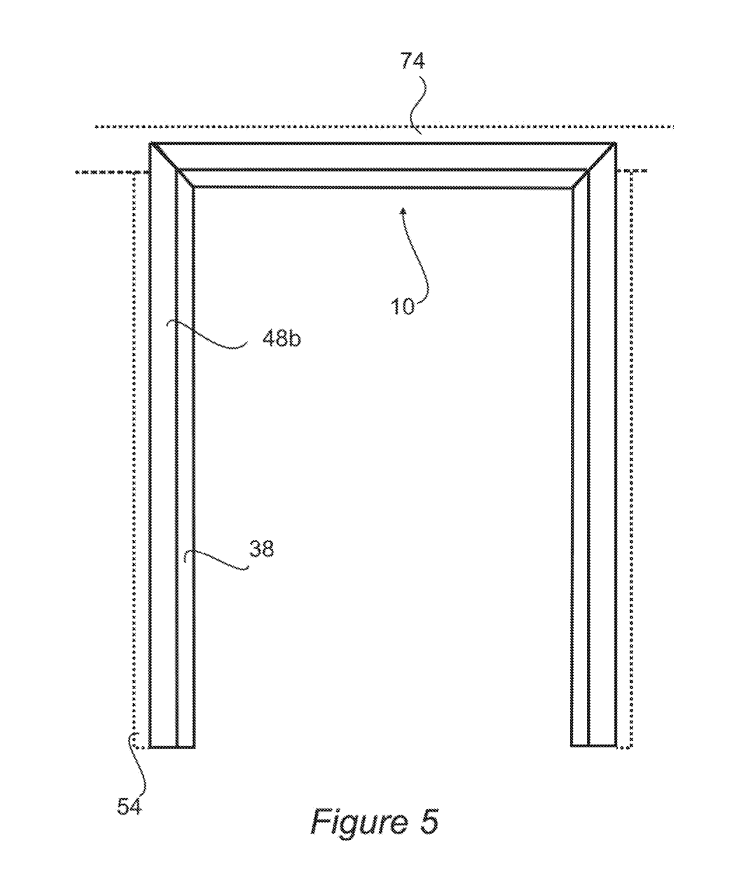

FIG. 6 is a horizontal cross section of an alternate embodiment 10a of this invention installed in a doorway with the door 50 in the closed position. The corner 52b is used to position the jamb 10a tightly against the corner of the stud 54. The other corner 52a receives the corner of the door 50. Side 98 functions as a door stop. The vertical cross section is analogous to this view in the same way that FIG. 3 is analogous to FIG. 3A.

FIG. 6A illustrates one way of conceiving of this alternate embodiment 10a. This embodiment 10a also has a central web 14 with a first surface 26 and a second surface 30. At each end 24a, 24b there is a rectangle 86, 90. The first side 94 of the first rectangle 86 is in line with the second surface 30 and the perpendicular side 98 of the first rectangle 86 projects away from the first surface 26. The first side 102 of the second rectangle 90 is in line with the first surface 26 and the perpendicular side 106 of the second rectangle 90 projects away from the second surface 30. The lengths of the sides 98, 106 are greater than the thickness T of the web 14. Also, the lengths L′ of the perpendicular sides 98, 98a and in line sides 102, 102a sides are the same as the thickness W of the wallboard.

As illustrated in FIG. 6, wallboard 62 is cut to fit around the doorway. Since wallboard 62 is frangible, the cut edge 66a is typically rough and not at a perfect angle. Therefore, later on, spackle, with or without tape, or equivalent is used to fill in the gaps 70a. Tape can be extended to cover the other first side 94a or the other perpendicular side 106a.

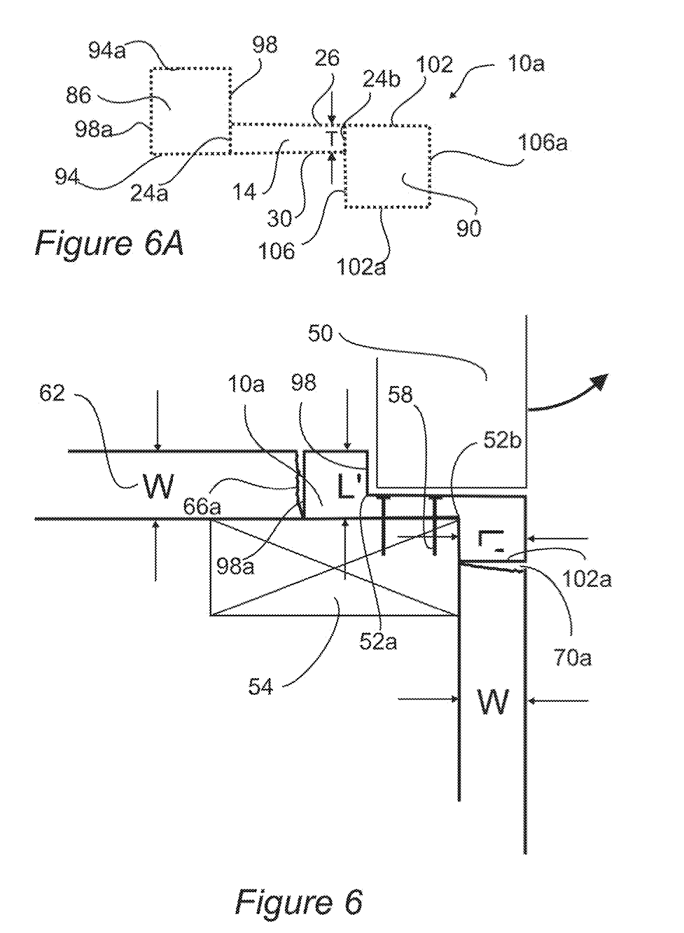

FIG. 7 is a view of a small segment of this alternate embodiment 10a from one end 110, the view from the other end being identical. FIG. 7A is a view of a small segment of this alternate embodiment 10a looking at one surface 26 and the other perpendicular side 94a of the first rectangle 86. FIG. 7B is a view of a small segment of this alternate embodiment 10a looking at one perpendicular side 98 and the other perpendicular side 106a of the second rectangle 90. FIG. 7C is a view of a small segment of this alternate embodiment 10a looking at the other surface 30 and the other first side 102a of the second rectangle 90. FIG. 7D is a view of a small segment of this alternate embodiment 10a looking at the other perpendicular side 106 and the other perpendicular side 98a of the first rectangle 86.

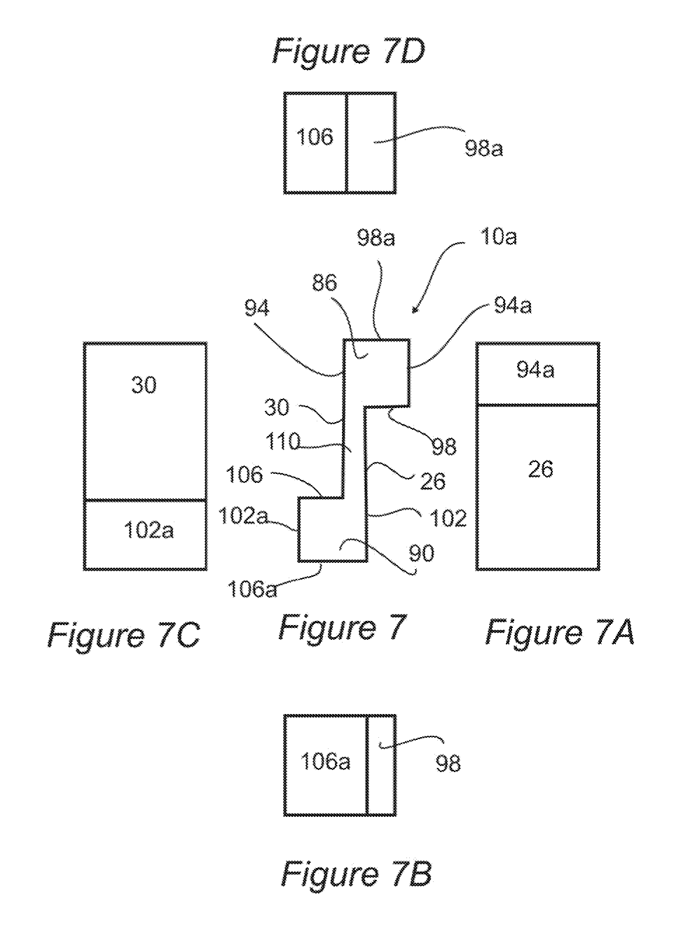

FIG. 8 is a horizontal cross section of another alternate embodiment 10b of this invention installed in a doorway with the door 50 in the closed position. The corner 176b is used to position the jamb 10b tightly against the corner of the stud 54. The other corner 176a receives the corner of the door 50. Sides 154 and 126 function as a door stop. The vertical cross section is analogous to this view in the same way that FIG. 3 is analogous to FIG. 3A.

FIG. 8A illustrates one way of conceiving of the other alternate embodiment 10b of this invention. This embodiment 10b also has a central web 14 with a first surface 26 and a second surface 30. There is a first rectangular section 114 at the first side 24a. The first rectangular section 114 has a first side 122, two perpendicular sides 126, 128 and an opposite side 130. The first side 122 and perpendicular sides 126, 128 are at right angles to each other and the first side 122 and the opposite side 130 are parallel to each other. The lengths of the sides 126, 142 are greater than the thickness T of the web 14. The lengths L″ of sides 128, 126, 138 and 140 are the same as the thickness W of the wallboard

There is a second rectangular section 134 at the second side 24b. The second rectangular section 134 has two first sides 138, 140 a perpendicular side 142 and an opposite side 146. The first sides 138, 140 and perpendicular side 142 are at right angles to each other and the perpendicular side 142 and the opposite side 146 are parallel to each other.

The first side 122 of the first rectangular section 114 is in line with the second surface 30 and the perpendicular side 126 of the first rectangular section 114 projects away from the first surface 26.

The first side 138 of the second rectangular 134 section is in line with the first surface 26 and the perpendicular side 142 of the second rectangular section 134 projects away from the second surface 30.

There is a third rectangular section 150 at the opposite side 130 of the first rectangular section 114. The third rectangular section 150 has two first sides 154, 156 and two perpendicular sides 158, 160 perpendicular to each other. The perpendicular sides 158, 160 of the third rectangular section 150 are longer than the opposite side 130 of the second rectangular section 114. The first side 154 of the third rectangular section 150 is in line with the perpendicular side 126 of the first rectangular section 114 and the perpendicular sides 158, 160 of the third rectangular section are parallel to the opposite 130 side of the first rectangular section 114.

There is a fourth rectangular section 162 at the opposite side 146 of the second rectangular 134 section. The fourth rectangular section 162 has two first sides 166, 168 and two perpendicular sides 170, 172 perpendicular to each other. The perpendicular sides 170, 172 of the fourth rectangular section 162 are longer than the opposite side 146 of the second rectangular section 134. The first side 166 of the fourth rectangular section 162 is in line with the first side 138 of the second rectangular section 134 and the sides 170, 172 of the fourth rectangular section 162 are parallel to the opposite side 146 of the fourth rectangular section 162.

Wallboard 62 is cut to fit around the doorway. Since wallboard 62 is frangible, the cut edge 66b is typically rough and not at a perfect angle. However, the cut edge 66b slides in to pockets 174 that are formed between the third 150 and fourth 162 rectangular sections and the stud 54. In this way any gaps 70b are hidden from view.

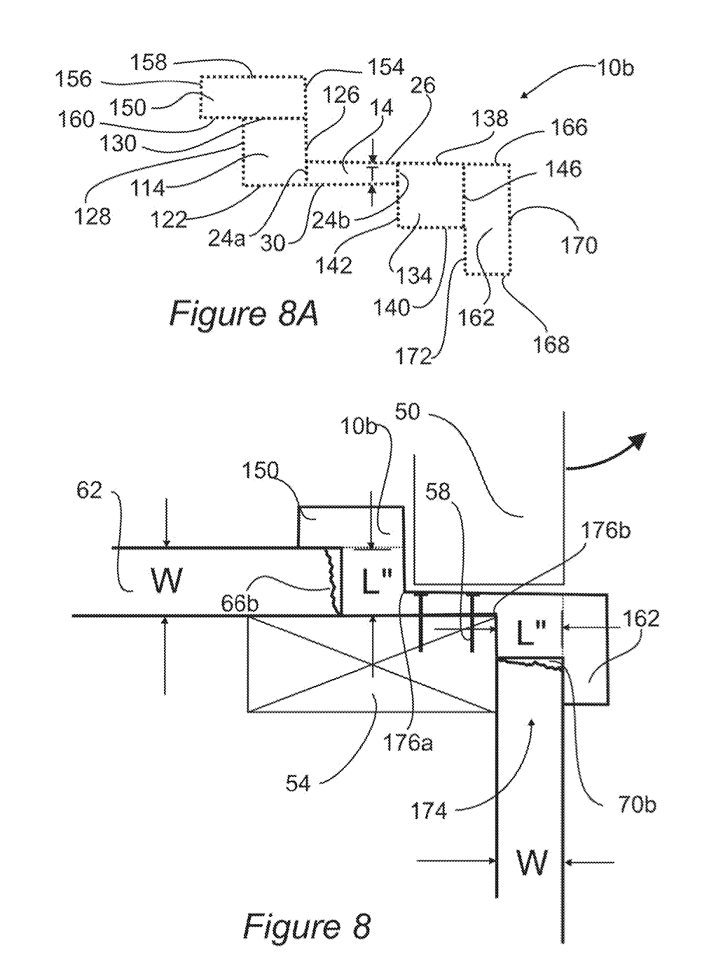

FIG. 9 is a view of a small segment of this alternate embodiment 10b from one end 174, the view from the other end being the mirror image. FIG. 9A is a view of a small segment of this alternate embodiment 10b looking at surfaces 168, 140, 30, 122 and 160. FIG. 9B is a view of a small segment of this alternate embodiment 10b looking at surface 156, 128, 142 and 172. FIG. 9C is a view of a small segment of this alternate embodiment 10b looking at surfaces 158, 26, 138 and 166. FIG. 9D is a view of a small segment of this alternate embodiment 10b looking at surfaces 154, 126 and 170.

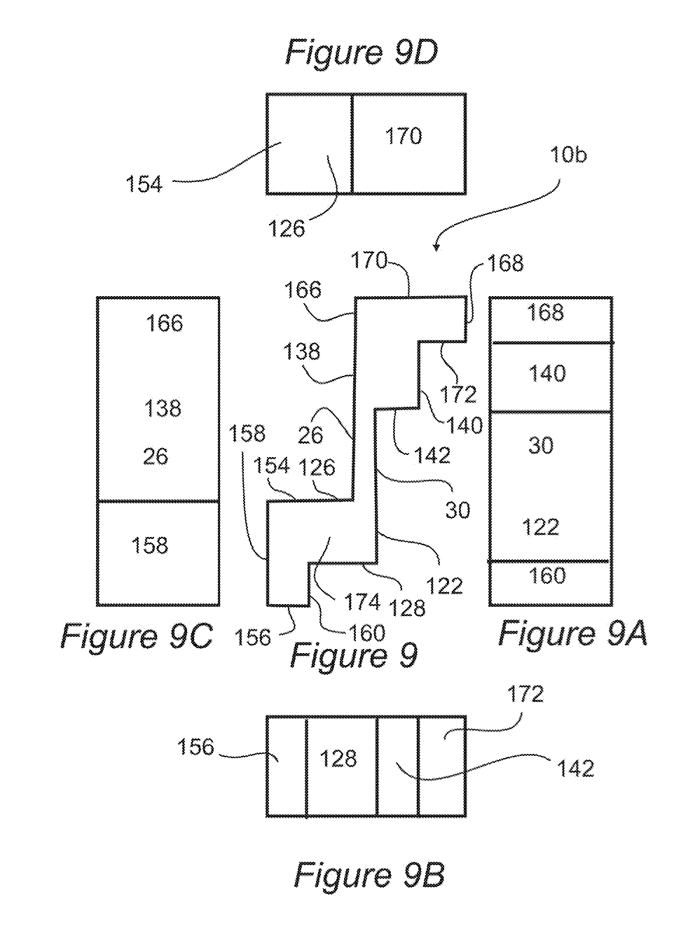

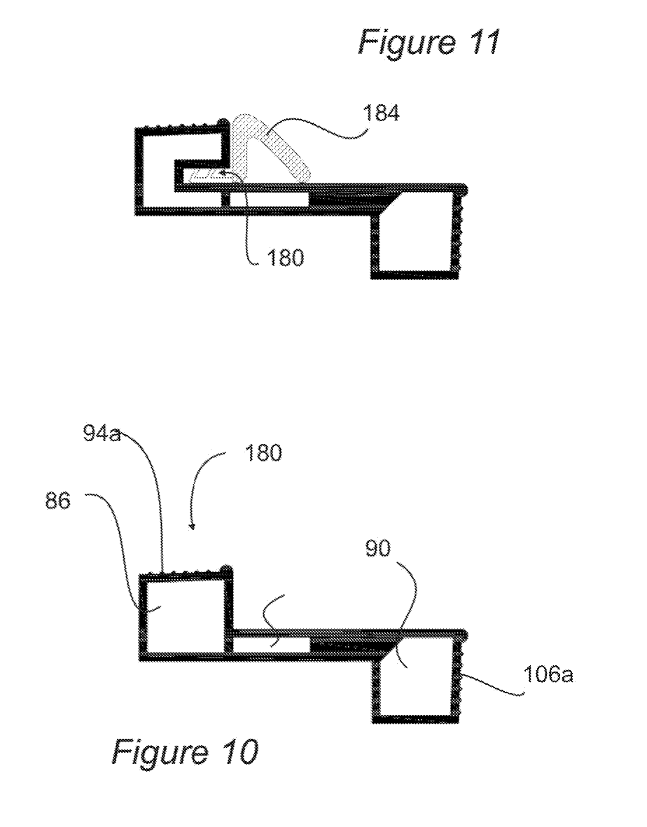

FIG. 10 shows some variations of this invention illustrated with the alternate embodiment 10a. In this embodiment the web 14 and rectangles 86, 90 are hollow and three dimensional decoration 180 is applied to sides 94a and 106a FIG. 11 shows further variations of this invention illustrated with the alternate embodiment 10a. In this embodiment there is a kerf 180 in one of the rectangles 86 into which a gasket or seal 184 is fastened. This gasket or seal 184 is intended to absorb the impact from closing of the door 50 and provide an air tight seal between the door 50 and the jamb 10.

Those that are familiar with the art to which this invention applies will recognize certain symmetrical features of this invention. Further they will recognize that shapes other than rectangles, triangles and squares could be utilized in this invention.

Other shapes that would work with this invention would be parallelograms, circles, ovals, hexagons, octagons, etc. and their combinations.

The following reference numerals are used on FIGS. 1 through 11:
10 preferred embodiment
10a first alternate embodiment
10c second alternate embodiment
12a one end of preferred embodiment
12b other end of preferred embodiment
14 central web
16 corner
16a door receiving corner
16b corner guide
18 first right triangle
22 second right triangle
24a first side of central web
24b second side of central web
26 first surface of central web
30 second surface of central web
34 adjacent side of first right triangle
38 opposite side of first right triangle
42 adjacent side of second right triangle
46 opposite side of second right triangle
48a hypotenuse of first right triangle
48b hypotenuse of second right triangle
50 door
52a door receiving corner
52b corner guide
54 stud
58 nail
62 wallboard
66 cut surface
66a cut edge
70 gap
70a gap
74 header
86 first rectangle of first alternate embodiment
90 second rectangle of first alternate embodiment
94 first side of first rectangle of first alternate embodiment
94a other first side of first rectangle of first alternate embodiment
98 perpendicular side of first rectangle of first alternate embodiment
98a other perpendicular side of first rectangle of first alternate embodiment
102 first side of second rectangle of first alternate embodiment
102a other first side of second rectangle of first alternate embodiment
106 perpendicular side of second rectangle of first alternate embodiment
106a other perpendicular side of second rectangle of first alternate embodiment
114 first rectangular section of second alternate embodiment
122 first side of first rectangular section of second alternate embodiment
126 perpendicular side of first rectangular section of second alternate embodiment
128 other perpendicular side of first rectangular section of second alternate embodiment
130 opposite side of first rectangular section of second alternate embodiment
134 second rectangular section of second alternate embodiment
138 first side of second rectangular section of second alternate embodiment
140 other first side of second rectangular section of second alternate embodiment
142 perpendicular side of second rectangular section of second alternate embodiment
146 opposite side of second rectangular section of second alternate embodiment
150 third rectangular section of second alternate embodiment
154 first side of third rectangular section of second alternate embodiment
156 other first side of third rectangular section of second alternate embodiment
158 perpendicular side of third rectangular section of second alternate embodiment
160 other perpendicular side of third rectangular section of second alternate embodiment
162 fourth rectangular section of second alternate embodiment
166 first side of fourth rectangular section of second alternate embodiment
168 other first side of fourth rectangular section of second alternate embodiment
170 perpendicular side of fourth rectangular section of second alternate embodiment
172 other perpendicular side of fourth rectangular section of second alternate embodiment
176a door receiving corner
176b corner guide
180 kerf
184 gasket
L length of sides 38 and 42
L′ length of sides 98, 98a, 102 and 102a
L″ length of sides 128, 126, 138 and 140
T thickness of web
W thickness of wallboard

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. An elongated structure comprising:
a) a central web having a first surface, a second surface, a first side and a second side;
b) a first right triangular section at said first side;
c) a second right triangular section at said second side;
d) an adjacent leg of said first right triangular section being in line with said second surface; an opposite leg of said first right triangular section projecting away from said first surface; and
e) an adjacent leg of said second right triangular section being in line with said first surface; an opposite leg of said second right triangular section projecting away from said second surface.

2. An elongated structure as claimed in claim 1 further comprising a stud and a header assembled to form a door opening; said elongated structure fastened to said stud and header whereby a door frame is created.

3. An elongated structure as claimed in claim 2 further comprising wallboard fitted to said elongated structure and fastened to said stud and header.

4. An elongated structure as claimed in claim 1 in which at least one of said triangular sections is hollow.

5. An elongated structure as claimed in claim 1 in which said central web is hollow.

6. An elongated structure as claimed in claim 1 in which one of said triangular sections has a kerf intersecting its opposite side and further comprising a seal affixed in said kerf.

7. An elongated structure as claimed in claim 1 further comprising a three dimensional decoration on a hypotenuse of at least one of said triangular sections.

8. An elongated structure comprising:
a) a central web having a first surface a second surface, a first side and a second side;
b) a first rectangular section at said first side;
c) a second rectangular section at said second side;
d) a first side of said first rectangular section being in line with said second surface; a perpendicular side of said first rectangular section projecting away from said first surface; and
e) a first side of said second rectangular section being in line with said first surface; a perpendicular side of said second rectangular section projecting away from said second surface.

9. An elongated structure as claimed in claim 8 further comprising a stud and a header assembled to form a door opening; said elongated structure fastened to said stud and header whereby a door frame is created.

10. An elongated structure as claimed in claim 9 further comprising wallboard fitted to said elongated structure and fastened to said stud and header.

11. An elongated structure as claimed in claim 8 in which at least one of said rectangular sections is hollow.

12. An elongated structure as claimed in claim 8 in which said central web is hollow.

13. An elongated structure as claimed in claim 8 in which said first rectangle has a kerf intersecting its perpendicular side and further comprising a seal affixed in said kerf.

14. An elongated structure as claimed in claim 8 further comprising a three dimensional decoration on a side opposite said first side of said first rectangular section.

15. An elongated structure as claimed in claim 8 further comprising a three dimensional decoration on a side opposite said perpendicular side of said second rectangular section.

16. An elongated structure comprising:
a) a central web having a first surface, a second surface, a first side and a second side;
b) a first rectangular section at said first side; said first rectangular section having a first side, a perpendicular side, and an opposite side; said first side and perpendicular side being at right angles to each other; said first side and said opposite side being parallel to each other;
c) a second rectangular section at said second side; said second rectangular section having a first side, a perpendicular side and an opposite side; said first side, and perpendicular side being at right angles to each other and said perpendicular side and said opposite side being parallel to each other.
d) said first side of said first rectangular section being in line with said second surface and said perpendicular side of said first rectangular section projecting away from said first surface;
e) said first side of said second rectangular section being in line with said first surface and said perpendicular side of said second rectangular section projecting away from said second surface;
f) a third rectangular section at said opposite side of said first rectangular section; said third rectangular section having a first side, and a perpendicular side, perpendicular to each other; said perpendicular side of said third rectangular section being longer than said opposite side of said second rectangular section; said first side of said third rectangular section being in line with said perpendicular side of said first rectangular section; said perpendicular side of said third rectangular section being parallel to said opposite side of said first rectangular section; and
g) a fourth rectangular section at said opposite side of said second rectangular section; said fourth rectangular section having a first side, and a perpendicular side, perpendicular to each other; said perpendicular side of said fourth rectangular section being longer than said opposite side of said second rectangular section; said first side of said fourth rectangular section being in line with said first side of said second rectangular section; said perpendicular side of said fourth rectangular section being parallel to said opposite side of said second rectangular section.

17. An elongated structure as claimed in claim 16 further comprising a stud and a header assembled to form a door opening; said elongated structure fastened to said stud and header whereby a door frame is created.

18. An elongated structure as claimed in claim 17 further comprising wallboard fitted to said elongated structure and fastened to said stud and header.

19. An elongated structure as claimed in claim 16 in which at least one of said rectangular sections is hollow.

20. An elongated structure as claimed in claim 16 in which said central web is hollow.

21. An elongated structure as claimed in claim 16 in which said first rectangular section has a kerf intersecting its perpendicular side and further comprising a seal affixed in said kerf.

22. An elongated structure as claimed in claim 16 further comprising a three dimensional decoration on said perpendicular side of said third rectangular section.

23. An elongated structure as claimed in claim 16 further comprising a three dimensional decoration on said perpendicular side of said fourth rectangular section.

24. A method of constructing a door frame in a door opening in framing comprising the steps of:
a) obtaining a jamb molding comprising;
i) a central web having a first surface a second surface, a first side and a second side;
ii) a first right triangular section at said first side;
iii) a second right triangular section at said second side;
iv) an adjacent leg of said first right triangular section being in line with said second surface; an opposite leg of said first right triangular section projecting away from said first surface; and
v) an adjacent leg of said second right triangular section being in line with said first surface; an opposite leg of said second right triangular section projecting away from said second surface;
b) cutting said jamb molding to size;
c) fastening said jamb molding to said framing;
d) cutting wallboard as accurately as possible to match said fastened jamb molding;
e) fastening said wallboard to said framing; and
f) patching any spaces between said fastened wallboard and fastened jamb molding with spackle.

25. A method as claimed in claim 24 in which at least one of said triangular sections is hollow.

26. A method as claimed in claim 24 in which said central web is hollow.

27. A method as claimed in claim 24 further comprising the steps of:
a) forming a kerf intersecting its opposite side in one of said triangles;
b) providing an impact absorbing seal; and
c) affixing said seal in said kerf.

28. A method as claimed in claim 24 further comprising the step of forming a three dimensional decoration on a hypotenuse of at least one of said triangular sections.

29. A method of constructing a door frame in a door opening in framing comprising the steps of:
a) obtaining a jamb molding comprising;
i) a central web having a first surface a second surface, a first side and a second side;
ii) a first rectangular section at said first side;
iii) a second rectangular section at said second side;
iv) a first side of said first rectangular section being in line with said second surface; a perpendicular side of said first rectangular section projecting away from said first surface; and
v) a first side of said second rectangular section being in line with said first surface; a perpendicular side of said second rectangular section projecting away from said second surface;
b) cutting said jamb molding to size;
c) fastening said jamb molding to said framing;
d) cutting wallboard as accurately as possible to match said fastened jamb molding;
e) fastening said wallboard to said framing; and
f) patching any spaces between said fastened wallboard and fastened jamb molding with spackle.

30. A method as claimed in claim 29 in which at least one of said rectangular sections is hollow.

31. A method as claimed in claim 29 in which said central web is hollow.

32. A method as claimed in claim 29 further comprising the steps of:
a) forming a kerf intersecting its perpendicular side in said first rectangle;
b) providing an impact absorbing seal; and
c) affixing said seal in said kerf.

33. A method as claimed in claim 29 further comprising the step of forming a three dimensional decoration on a side opposite said first side of said first rectangular section.

34. A method as claimed in claim 29 further comprising the step of forming a three dimensional decoration on a side opposite said perpendicular side of said second rectangular section.

35. A method of constructing a door frame in a door opening in framing comprising the steps of:
a) obtaining a jamb molding comprising;
i) a central web having a first surface, a second surface, a first side and a second side;
ii) a first rectangular section at said first side; said first rectangular section having a first side, a perpendicular side, and an opposite side; said first side and perpendicular side being at right angles to each other; said first side and said opposite side being parallel to each other;
iii) a second rectangular section at said second side; said second rectangular section having a first side, a perpendicular side and an opposite side; said first side, and perpendicular side being at right angles to each other and said perpendicular side and said opposite side being parallel to each other.
iv) said first side of said first rectangular section being in line with said second surface and said perpendicular side of said first rectangular section projecting away from said first surface;
v) said first side of said second rectangular section being in line with said first surface and said perpendicular side of said second rectangular section projecting away from said second surface;
vi) a third rectangular section at said opposite side of said first rectangular section; said third rectangular section having a first side, and a perpendicular side, perpendicular to each other; said perpendicular side of said third rectangular section being longer than said opposite side of said second rectangular section; said first side of said third rectangular section being in line with said perpendicular side of said first rectangular section; said perpendicular side of said third rectangular section being parallel to said opposite side of said first rectangular section; and
vii) a fourth rectangular section at said opposite side of said second rectangular section; said fourth rectangular section having a first side, and a perpendicular side, perpendicular to each other; said perpendicular side of said fourth rectangular section being longer than said opposite side of said second rectangular section; said first side of said fourth rectangular section being in line with said first side of said second rectangular section; said perpendicular side of said fourth rectangular section being parallel to said opposite side of said second rectangular section;
b) cutting said jamb molding to size;
c) fastening said jamb molding to said framing whereby a slot is created between said framing and said jamb molding;
d) cutting wallboard to match said fastened jamb molding;
e) sliding said wallboard into said slot; and
f) fastening said wallboard to said framing.

36. A method as claimed in claim 35 in which at least one of said rectangular sections is hollow.

37. A method as claimed in claim 35 in which said central web is hollow.

38. A method as claimed in claim 35 further comprising the steps of:
a) forming a kerf intersecting its perpendicular side in said first rectangular section;
b) providing an impact absorbing seal; and
c) affixing said seal in said kerf.

39. A method as claimed in claim 35 further comprising the step of forming a three dimensional decoration on said perpendicular side of said third rectangular section.

40. A method as claimed in claim 35 further comprising the step of forming a three dimensional decoration on said perpendicular side of said fourth rectangular section.

41. An elongated structure comprising:
a) a central web having a first side and a second side;
b) a first regularly shaped section at said first side; said first regularly shaped section having at least one side;
c) a second regularly shaped section at said second side; said second regularly shaped section having at least one side; and
d) said elongated structure having a shape adapted to fasten to two adjacent sides of a stud.

42. An elongated structure as claimed in claim 41 further comprising a stud and a header assembled to form a door opening; said elongated structure fastened to said stud and header whereby a door frame is created.

43. An elongated structure as claimed in claim 41 further comprising wallboard fitted to said elongated structure and fastened to said stud and header.

44. An elongated structure as claimed in claim 41 in which at least one of said shaped sections is hollow.

45. An elongated structure as claimed in claim 41 in which said central web is hollow.

46. An elongated structure as claimed in claim 41 further comprising a seal affixed to one of said shaped sections, said seal affixed to provide a door seal.

47. An elongated structure as claimed in claim 41 further comprising a three dimensional decoration on at least one of said sides.

48. A method of constructing a door frame in a door opening in framing comprising the steps of:
a) obtaining a jamb molding comprising;
i) a central web having a first side and a second side;
ii) a first regularly shaped section at said first side; said first regularly shaped section having at least one side;
iii) a second regularly shaped section at said second side; said second regularly shaped section having at least one side; and
iv) said elongated structure having a shape adapted to fasten to two adjacent sides of a stud;
b) cutting said jamb molding to size;
c) fastening said jamb molding to said framing;
d) cutting wallboard as accurately as possible to match said fastened jamb molding;
e) fastening said wallboard to said framing; and
f) patching any spaces between said fastened wallboard and fastened jamb molding with spackle.

49. A method as claimed in claim 48 in which at least one of said shaped sections is hollow.

50. A method as claimed in claim 48 in which said central web is hollow.

51. A method as claimed in claim 48 further comprising the steps of:
a) providing an impact absorbing seal; and
b) affixing said seal to one of said shapes to form a door seal.

52. A method as claimed in claim 48 further comprising the step of forming a three dimensional decoration on at least one of said sides.
